(19) United States
(12) Patent Application Publication
(10) Pub. No.: US 2003/0210140 A1
(43) Pub. Date: Nov. 13, 2003

(54) Wireless management of portable toilet facilities

(76) Inventors: Raymond J. Menard, Hastings, MN (US); Curtis E. Quady, Burnsville, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/310,713

(22) Filed: Dec. 5, 2002

Related U.S. Application Data
(60) Provisional application No. 60/338,446, filed on Dec. 6, 2001.

(51) Int. Cl. G08B 1/00

(52) U.S. Cl. 340/531; 340/539.13

(57) ABSTRACT

A portable sanitation unit includes one or more sensors and a wireless transmitter. The sensor provides a signal to the wireless transmitter based on a fluid level, the unit location, a temperature, or other detected condition. The transmitter communicates with a remote monitoring facility. The monitoring facility receives a coded signal from the sanitation unit which includes unit identification information, condition information and location. In one embodiment, a secure website, accessible from the internet, displays data corresponding to each of a number of monitored sanitation units. A receiver coupled to the sanitation unit receives wireless control signals and data from the monitoring facility.

### RELATED APPLICATION

This application claims priority to U.S. Provisional Patent Application Serial No. 60/338,446, filed on Dec. 6, 2001, entitled WIRELESS MANAGEMENT OF PORTABLE TOILET FACILITIES, which is herein incorporated by reference.

### TECHNICAL FIELD

This invention relates generally to wireless management of remote equipment and particularly, but not by way of limitation, to systems and methods of remotely communicating with one or more sensors of a portable toilet system.

### BACKGROUND

Adequate restroom facilities are not always conveniently provided at construction sites, parks, sporting events or at public gathering locations. Market demand for portable toilets, or portable sanitation units, has led to an industry tailored to providing sanitation services in both sewered and un-sewered locations.

In some cases, un-sewered locations are remote from high traffic areas and as such, are prone to neglect, vandalism or theft. For example, a portable sanitation unit placed in service at a building construction site may be subject to vandalism during weekends when construction workers are not present.

What is needed is a system and method for remotely monitoring and controlling a portable toilet unit.

### SUMMARY

A portable toilet unit is equipped with one or more electronic sensors and a wireless communication module. In one embodiment, the unit is equipped with a global positioning system (GPS) receiver to generate geographical position information. The position information is communicated wirelessly to a remote monitoring facility by means of the wireless communication device. The monitoring facility communicates with field service personnel and others for management support of the unit. The unit can also communicate with field service personnel for purposes of automatically requesting service. Other sensors are also contemplated. For example, level sensors can be provided. The level sensors provide data related to handwash fluid, holding tank levels and other operational parameters of the unit. Sensors can also detect the inclination or orientation of the unit or detect unusually high acceleration forces. A user-operable “panic button” or “assistance button” can provide the means for requesting emergency police, medical or fire assistance. Also, a microphone or camera can be activated automatically, or remotely (from the monitoring facility) for purposes of capturing data.

Other aspects of the invention will be apparent on reading the following detailed description of the invention and viewing the drawings that form a part thereof.

This summary is intended to provide a brief overview of some of the embodiments of the present system, and is not intended in an exclusive or exhaustive sense, and the scope of the present subject matter is to be determined by the attached claims and their equivalents.

### BRIEF DESCRIPTION OF THE DRAWINGS

In the drawings, like numerals describe substantially similar components throughout the several views. Like numerals having different letter suffixes represent different instances of substantially similar components.

FIG. 1 includes a perspective view of a portable sanitation unit with a wireless communication module.

FIG. 2 includes a block diagram of a monitored portable sanitation unit.

FIG. 3 includes a block diagram of sensors coupled to a transmitter.

FIG. 4 includes a block diagram of a processor controlled transceiver with a variety of input modules and output modules.

FIG. 5 includes a flow chart of a method for operating a portable sanitation unit.

FIG. 6 includes a flow chart of a method for operating a portable sanitation unit.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents. In the drawings, like numerals describe substantially similar components throughout the several views. Like numerals having different letter suffixes represent different instances of substantially similar components.

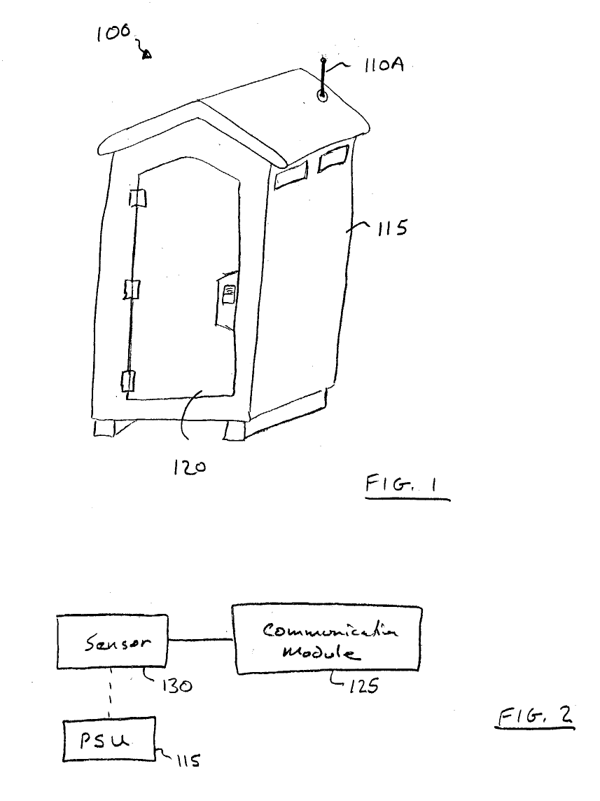

FIG. 1 illustrates system 100 according to the present subject matter. System 100 includes portable sanitation unit (PSU) 115. PSU 115 is an enclosure adapted to provide privacy for a user and includes entry door 120. Antenna 110A is coupled to a wireless communication module and to PSU 115. In the embodiment illustrated, antenna 110A is affixed to a roof structure of PSU 115. In one embodiment, antenna 110A is embedded in a surface of PSU 115, such as, for example, a wall surface. In one embodiment, antenna 110A is contained within a communication module.

PSU 115, in one embodiment, includes a toilet and a holding tank. In one embodiment, PSU 115 includes a urinal.

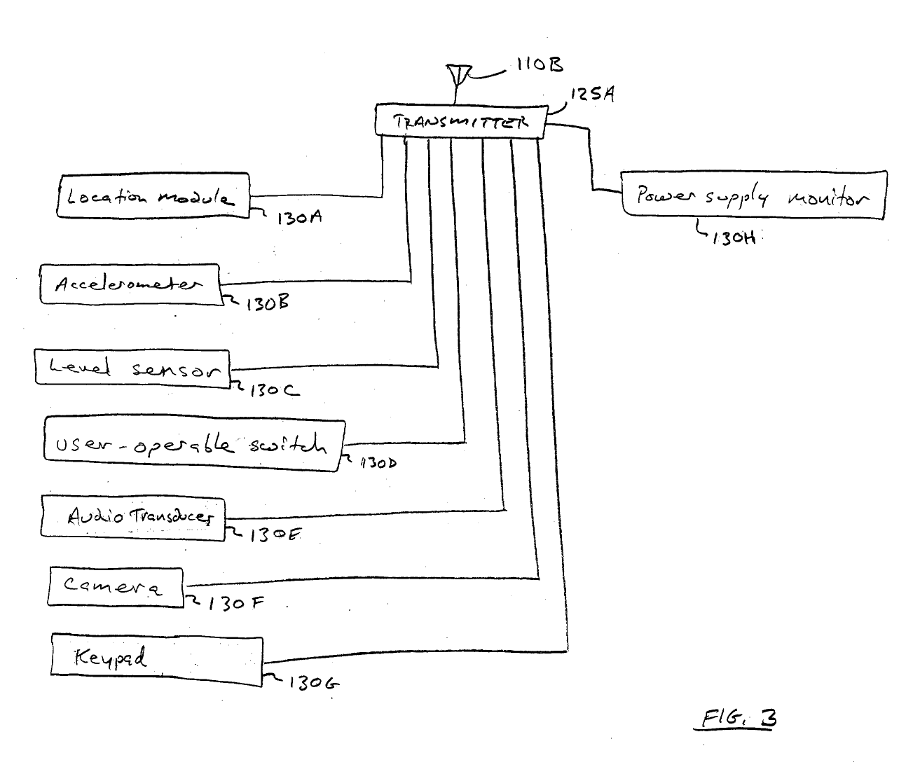

FIG. 2 illustrates a block diagram according to one embodiment of the present subject matter. Sensor 130 is coupled to PSU 115. Sensor 130 provides an electrical output signal to communication module 125. In one embodiment, an output signal from sensor 130 includes a digital signal. In one embodiment, an output signal from sensor 130 includes an analog signal. Communication module 125 transmits data based on the signal received from sensor 130.

Sensor 130, in one embodiment, includes a fluid level detector and is affixed to a tank of PSU 115. The tank may include an effluent tank, a fresh water tank, a soap dispenser tank, a perfume tank or a chemical tank. Sensor 130, in one embodiment, includes a float-based fluid sensor. In one embodiment, sensor 130 includes an optical fluid level sensor. In one embodiment, sensor 130 includes a capacitance-type fluid level sensor. In one embodiment, sensor 130 includes an in-use detector to determine if PSU 115 is currently occupied. For example, in one embodiment, sensor 130 includes a weight sensitive switch. Other types of sensors, including other types of fluid level sensors, are also contemplated.

Communication module 125, in one embodiment, includes a radio frequency (RF) transmitter. Module 125 transmits digital data based on the signal received from sensor 130. In one embodiment, communication module 125 transmits analog data. Module 125, in one embodiment, is coupled to antenna 110A of FIG. 1. Module 125 includes a wireless transmitter compatible with a cellular telephone or pager communication protocol.

Communication module 125, in one embodiment, includes a transceiver capable of both transmitting and receiving wireless signals. Communication module 125, in one embodiment, is adapted to receive an acknowledge signal confirming receipt of a transmitted signal. In one embodiment, communication module 125 is adapted to receive an instruction or other data from a remote site.

Communication module 125, in one embodiment, is adapted to communicate using an optical communication channel, including, for example, via an infrared communication link.

In one embodiment, communication module 125 includes an electrical connector adapted to be coupled with a computer via a matching connecter. The computer, for example, is portable and when connected, is able to received an electrical signal based on an output signal of sensor 130.

FIG. 3 illustrates RF transmitter 125A, with antenna 110B, coupled to a number of sensors, including transducers, modules and devices. In the figure, location module 130A is coupled to PSU 115 and is adapted to provide an output signal corresponding to a geographical location of PSU 115. Location data may be expressed in geographical longitudinal and latitudinal coordinates, a street address, a city, state, polar coordinates, or in another convenient measure describing a point in a two dimensional plane. In one embodiment, location data includes altitude information. For example, in one embodiment, location information may indicate that PSU 115 is 40′ above ground level or is located on the fourth floor of a commercial building at a particular street address.

Location module 130A, in various embodiments, includes a GPS receiver, a long range navigation (LORAN), a hybrid location system or other location determining technology. In one embodiment, location module 130A provides data concerning the location information including, for example, the number of satellites currently being tracked, signal strength, version number of firmware executing on a GPS receiver or other data relative to location module 130A.

In one embodiment, accelerometer 130B is coupled to transmitter 125A. Accelerometer 130B provides an electronic signal to transmitter 125A based on a detected acceleration relative to PSU 115. For example, in one embodiment, accelerometer 130B functions as a tip-over sensor. As a tip-over sensor, accelerometer 130B is affixed to PSU 115 with an orientation tailored to detect the gravitational pull of the earth.

In one embodiment, level sensor 130C is coupled to transmitter 125A. Level sensor 130C provides an electronic signal to transmitter 125A based on a measured level of a fluid or other materials. For example, in one embodiment, level sensor 130C includes a float-type or capacitance-type fluid sensor and provides an output signal based on a tank level. In one embodiment, level sensor 130C includes a sensor to determine a remaining quantity of paper products, such as toilet tissue, sanitary wipes or hand towels. Level sensor 130C, in one embodiment, provides a signal based on a measured resistance.

In one embodiment, user operable switch 130D is coupled to transmitter 125A. When actuated by a user, switch 130D provides an electronic signal to transmitter 125A. A message requesting emergency assistance is transmitted by transmitter 125A upon actuation of switch 130D. A suitable label positioned near switch 130D indicates that emergency personnel will be notified upon actuation of switch 130D. For example, an occupant of PSU 115 may opt to actuate switch 130D in the event of a medical emergency. In one embodiment, switch 130D is positioned on an interior surface of PSU 115. In one embodiment, switch 130D is positioned on an exterior surface of PSU 115.

In one embodiment, audio transducer 130E is coupled to transmitter 125A. In one embodiment, transducer 130E includes a microphone. In one embodiment, transducer 130E provides an electronic signal to transmitter 125A based on nearby detected audio. For example, after actuating switch 130D, a voice communication channel is established between PSU 115 and a remote service provider. The remote service provider can receive verbal information from the occupant based on audio detected by audio transducer 130E. In one embodiment, audio transducer 130E is positioned on an interior surface of PSU 115. In one embodiment, audio transducer 130E is positioned on an exterior surface of PSU 115.

In one embodiment, camera 130F is coupled to transmitter 125A. In one embodiment, camera 130F includes a video camera. In one embodiment, camera 130F provides an electronic signal to transmitter 125A based on detected light in the field of view. For example, after actuating switch 130D, a communication channel is established between PSU 115 and a remote service provider, thus allowing a remote service provider to receive a visual image depicting the scene at PSU 115. In one embodiment, camera 130F is positioned on an interior surface of PSU 115. In one embodiment, camera 130F is positioned on an exterior surface of PSU 115.

In one embodiment, keypad 130G is coupled to transmitter 125A. When actuated by a user, keypad 130G provides an electronic signal to transmitter 125A. Keypad 130G includes one or more user operable keys, each having a predetermined function associated with communicating with a remote service provider. Labels on or near the keypad indicate to a user the function of particular keys of keypad 130G. For example, an occupant of PSU 115 may opt to actuate a particular key of keypad 130G to submit a request for unscheduled servicing of PSU 115. As further examples, in one embodiment, a first key is programmed to summon emergency medical help, a second key is programmed to summon police service and a third key is programmed to summon fire fighting services. In one embodiment, keypad 130G is positioned on an interior surface of PSU 115. In one embodiment, keypad 130G is positioned on an exterior surface of PSU 115. Keypad 130G, in one embodiment, is accessible to service personnel by moving a protective panel, and keypad 130G provides access to programming functions executed by processor 140.

In one embodiment, battery supply monitor 130H is coupled to transmitter 125A. Battery supply monitor 130H provides an electronic signal to transmitter 125A based on a power level of portable battery. The portable battery provides electrical power to the transmitter and other equipment of PSU 115. In one embodiment, PSU 115 includes a power cord for connecting to a metered electric service and a battery of PSU 115 is recharged whenever metered service is available. In one embodiment, a solar power cell provides charging voltage for a battery.

Other sensors and transducers coupled to transmitter 125A are also contemplated. For example, in one embodiment, a system monitor module provides a signal to transmitter 125A based on detected conditions for the present system. In one embodiment, sensor 130 includes an inclinometer coupled to PSU 115. The output of the inclinometer indicates an angle at which PSU 115 is positioned relative to the gravitational force of the earth.

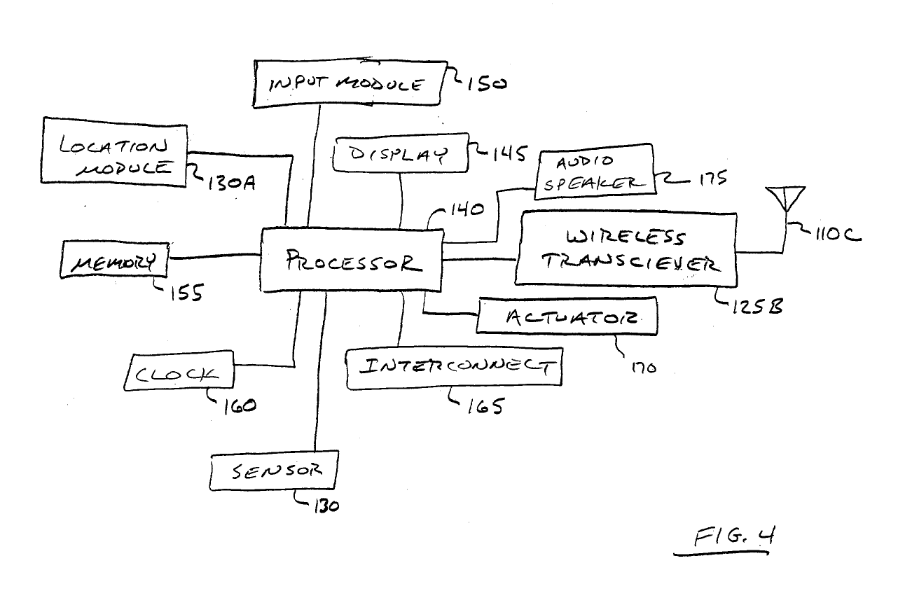

FIG. 4 illustrates one embodiment of the present subject matter. In the figure, processor 140 is coupled to wireless transceiver 125B. Wireless transceiver 125B is coupled to antenna 110C. In the figure, processor 140 is coupled to display 145, input module 150, location module 130A, memory 155, clock 160, sensor 130, interconnect 165, actuator 170 and audio speaker 175.

Display 145, in various embodiments, includes a light emitting diode (LED) display, a liquid crystal display (LCD) or other type of user viewable display. In one embodiment, display 145 is positioned on an interior surface of PSU 115. In one embodiment, display 145 is positioned on an exterior surface of PSU 115. Display 145 conveys data corresponding to messages or data from a remote monitoring facility or messages or data corresponding to conditions at PSU 115.

Input module 150, in various embodiments, includes a magnetic card reader, a keypad (as described earlier relative to keypad 130G), a touchscreen or other input device. Alphanumeric data may be entered using input module 150. Data may include data supplied by a user information or service technician. Data may include software or parameters for use by processor 140. In one embodiment, input module 150 is positioned on an interior surface of PSU 115. In one embodiment, input module 150 is positioned on an exterior surface of PSU 115.

Memory 155 provides storage capacity for digital data and is accessible to processor 140. Memory 155, in various embodiments, includes random access memory (RAM) or read-only memory (ROM). Memory 155, in one embodiment, provides archival data storage corresponding to the history of PSU 115. For example, service records, detected event or conditions, and locations may be stored in memory 155. Information corresponding to data stored in memory 155 can be presented using display 145 or audio speaker 175 or communicated using interconnect 165 or transceiver 125B.

Clock 160 provides timing information to processor 140. In one embodiment, clock 160 provides date and time stamping data corresponding to location information or detected events or conditions. In one embodiment, processor 140 is configured to restrict access to PSU 115 after a predetermined period of time has elapsed since last serviced as measured by clock 160.

Sensor 130 provides an electrical signal corresponding to detected events or conditions associated with PSU 115. In one embodiment, more than one sensor is coupled to processor 140.

Interconnect 165, in various embodiments, provides an electrical connection or interface to allow a computer to interrogate, diagnose, upgrade or program the operation of system 100. In one embodiment, interconnect 165 includes a multi-conductor cable connector compatible with a computer. Programming executing on the computer allows a user to electronically interface with PSU 115 and access or adjust parameters and software executing on processor 140. In one embodiment, interconnect 165 includes a wireless short range RF coupling.

Actuator 170, in various embodiments, includes a mechanical actuator coupled to PSU 115. For example, in one embodiment, actuator 170 includes an electronically operable door lock and when the usage capacity of PSU 115 has been met or exceeded, (as determined by sensor 130 or upon receipt of a wireless signal received via transceiver 125B) processor 140 provides a signal to actuator 170 which sets the lock and prevents further use. In one embodiment, a predetermined wireless signal received from a service facility causes processor 140 to instruct actuator 170 to unlock door 120 on PSU 115, thus making the unit available for use. In one embodiment, actuator 170 is coupled to a toilet tissue dispenser mounted within PSU 115. Upon receipt of a predetermined signal, processor 140 operates actuator 170 to cause a replacement toilet tissue supply to become available for use. In one embodiment, actuator 170 is coupled to a valve on a chemical tank and upon receipt of a predetermined signal, the contents of the chemical tank are released. In one embodiment, the actuator is coupled to a heater element and upon detection of a predetermined temperature, via sensor 130, the heater is energized, thus elevating the temperature of PSU 115.

In one embodiment, processor 140 executes programming to operate a predetermined actuator based on a detected condition or event. For example, in one embodiment, if processor 140 receives a signal that indicates that the toilet tissue supply has been exhausted, then processor 140 causes a door lock to be activated. Inputs from multiple sensors or detectors can be combined to control the operation of an actuator. For example, if the central monitoring service determines that a customer credit limit has been exceeded and the PSU 115 remains at the customer's location beyond the contracted time period, then the door is secured by the lock under control of processor 140. In one embodiment, PSU 115 is made available for use based on payment received at a coin box or an authorized credit card. In one embodiment, a sensor coupled to PSU 115 determines if the coin box is in need of service and, if so, an appropriate signal is communicated to a central monitoring station. In one embodiment, a theft alarm sensor is coupled to PSU 115 and an alarm is triggered based on detected conditions or events.

In one embodiment, audio speaker 175 provides an audible output in response to receiving an electrical signal from processor 140. In one embodiment, audio speaker 175 functions as a microphone and thus, audio detected by speaker 175 is communicated to processor 140 via an electrical signal. In one embodiment, speaker 175 includes a piezoelectric element. Audio speaker 175, in one embodiment, allows bidirectional verbal communication between a remote service provider and a user at PSU 115. In one embodiment, speaker 175 is operated to sound an alarm for the benefit of users near the location of PSU 115.

In one embodiment, transceiver 125B includes an RF transceiver compatible with BLUETOOTH® technology, HomeRF® technology, cellular telephone technology, two-way pager technology, radio frequency (RF) technology, IEEE 802 technology and other wireless communication technology. BLUETOOTH® refers to a wireless, digital communication protocol using a low form factor transceiver that operates using spread spectrum frequency hopping at a frequency of around 2.45 GHz. BLUETOOTH® is a trademark registered by Telefonaktiebolaget LM Ericsson of Stockholm, Sweden and refers to technology developed by an industry consortium known as the BLUETOOTH® Special Interest Group. BLUETOOTH® operates at a frequency of approximately 2.45 GHz, utilizes a frequency hopping (on a plurality of frequencies) spread spectrum scheme, and as implemented at present, provides a digital data transfer rate of approximately 1 Mb/second. In one embodiment, transceiver 125B communicates digital data. In one embodiment, transceiver 125B communicates analog signals.

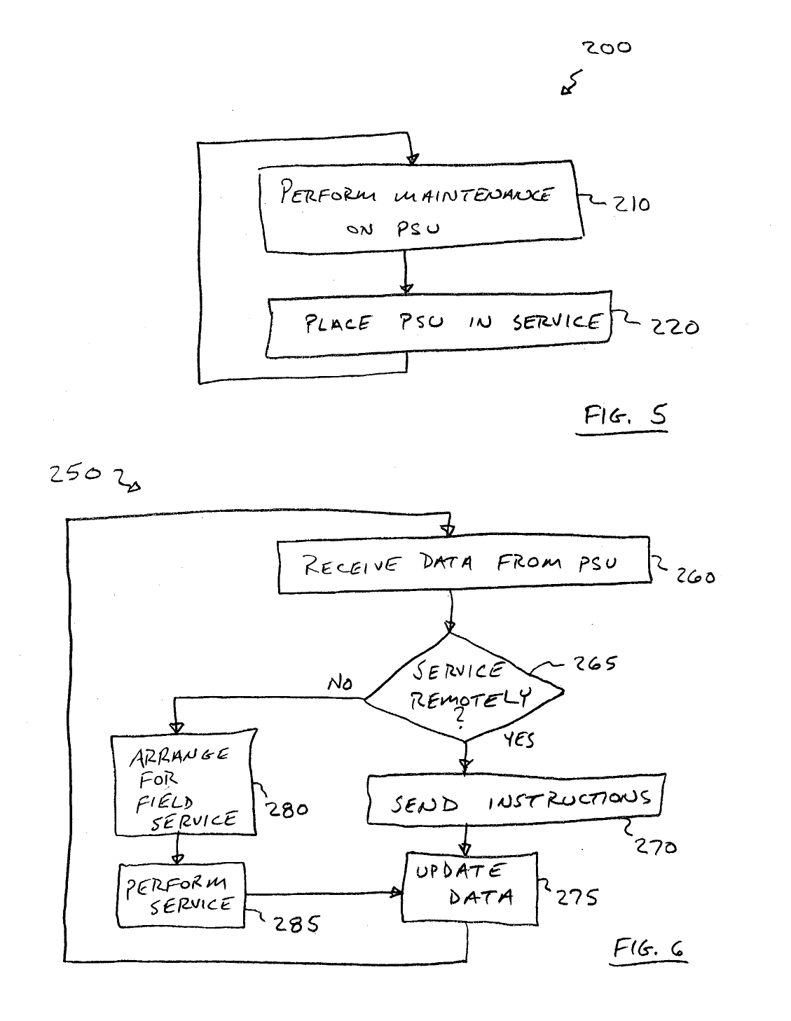

FIG. 5 illustrates a flow chart of method 200 for operating a portable sanitation unit. At 210, a service technician performs maintenance on PSU 115. Maintenance may include pumping effluent from a holding tank, replenishing a fresh water supply, replenishing hand soap, stocking toilet tissue and performing minor repairs. In one embodiment, maintenance also includes executing a routine to check the operational performance of any sensors, checking the power supply, curing any default conditions of processor 140 and preparing PSU 115 for service.

At 220, the service technician places PSU 115 in service. In one embodiment, this includes placing PSU 115 at a predetermined location. In one embodiment, placing PSU 115 in service includes setting processor 140 in a mode for accepting users.

Following a predetermined period time or number of uses, PSU 115 undergoes maintenance as indicated at 210, followed by return to service at 220.

FIG. 6 includes a flow chart of method 250 for operating a portable sanitation unit. At 260, the method includes receiving data from PSU 115. In one embodiment, receiving data includes establishing a wireless communication link and receiving coded data corresponding to detected events and conditions. For example, in one embodiment, receiving data includes receiving an identification code for the particular PSU 115, receiving holding tank fluid level information, toilet tissue information and geographical location information. In one embodiment, PSU 115 is programmed to transmit data at predetermined time periods. In one embodiment, PSU 115 is programmed to transmit data on occurrence of a predetermined condition. In one embodiment, PSU 115 is programmed to transmit data upon receipt of an inquiry command. The inquiry command may be manually supplied by a field service technician or wirelessly received from a remote location.

At 265, an inquiry is performed to determine if PSU 115 is in condition for remote servicing. For example, PSU 115 may have exceeded rated capacity for uses and servicing may entail securing PSU 115 to prevent further use. Thus, at 270, an instruction is sent to PSU 115 to cause an entry door to lock and prevent additional users from entering. As another example, at 270, an instruction is sent to PSU 115 to cause a chemical to be released into a holding tank. As another example, at 270, an instruction is sent to PSU 115 to bring a replacement supply of toilet tissue into position for use. At 275, data is updated to reflect the condition of PSU 115. For example, in one embodiment, updating data includes storing data in memory 155. In one embodiment, storing data includes storing data at a remote service facility.

If the inquiry at 265 indicates that PSU 115 cannot be serviced remotely, then, at 280, a command is sent to arrange for a field service technician to perform servicing of the unit. At 285, PSU 115 is serviced. At 275, updated data is stored.

Following updating of data at 275, method 250 loops back and again receives data at 260. It will be appreciated that other procedures may be involved and that the specified order is but one example only.

Monitoring Service and Field Service

In one embodiment, a mobile service vehicle is equipped with a wireless receiver for receiving data from PSU 115. In one embodiment, a handheld or portable computer is coupled to PSU 115 by an electrical connector, a wireless, short range RF channel, an infrared link, or other wireless link. A user-accessible keypad, and a display panel, affixed to PSU 115 allows an operator to diagnose the condition of a PSU.

According to one embodiment, a central monitoring service provides support for one or more portable sanitation units distributed throughout a geographic region. The central monitoring service coordinates servicing, delivery and retrieval of each PSU 115.

Data Structure

In one embodiment, the present subject matter includes a method of communicating digital data using a structured transmission protocol. The data communicated may be received, for example, by a fixed remote facility, a mobile service vehicle or a handheld receiver. In one embodiment, the handheld receiver includes a portable computer with a wireless communication channel. The data may be communicated wirelessly over radio frequency (RF) communication channels including, for example pager communication channels or cellular telephone communication channels. In one embodiment, the data is communicated using public switched telephone network (PSTN). In one embodiment, the data is communicated using digital data network communication channels, including for example, a local area network (LAN) or a wide area network (WAN) such as the internet. In one embodiment, the data is communicated by a combination of different communication channels.

In one embodiment, PSU 115 includes a wireless transmitter. Data is transmitted from PSU 115 corresponding to events or conditions detected at the PSU. In one embodiment, PSU 115 includes a wireless transceiver and data is communicated in a two-way exchange with a remote transceiver. Communicated data includes, for example, instructions and executable code as well as data corresponding to events or conditions detected at PSU 115.

The fields of data communicated between PSU 115 and a remote facility (which may include a mobile service vehicle) can be tailored to a particular application. For example, in one embodiment, one or more of the following fields of data is presented in a secure website accessible to authorized users.

PSU Identification Code

This field stores a unique serial number or other identification code and is used to identify the particular portable sanitation unit.

Registered Owner/Lessee Identification

This field identifies a registered owner of the PSU or the identity of a registered lessee.

Firmware Code

This field indicates the version release number of the particular firmware executing on a processor of the PSU. In one embodiment, firmware can be upgraded or remotely changed by wireless communication with PSU 115.

Location Data

The location data, according to one embodiment, includes global coordinates or coordinates relative to a particular location. The data may be decoded, by means of a look up table, to indicate a nearest street address or city. In the event of high rise construction or other complex structures, the GPS coordinates may indicate an altitude or floor level corresponding to the location of the PSU. In one embodiment, the signal strength of a GPS satellite transmitter is detected and stored in a memory.

Days at that Location

An internal clock, coupled to the processor is used to mark elapsed time, in hours, days or other units, during which the PSU has been at a particular location. In one embodiment, the particular location is noted in the location data field. In one embodiment, if the PSU location remains unchanged for a period of time greater than a predetermined amount (for example, 3 hours), then it is assumed that the PSU has been placed in service at that site, or placed out of service at that site and elapsed time accrues accordingly.

Date Last Serviced

A calendar/clock stores the most recent date for which field service was performed on the PSU.

Scheduled Retrieval Date

A scheduled date for retrieval of the PSU is stored in this field.

Most Recent Technician Identification

This field includes identification information for the most recent service technician.

Effluent Tank Fluid Level

This field indicates a tank fluid level. The effluent tank level is monitored by a fluid sensor. The fluid sensor may include a capacitive sensor, a float based sensor, optical sensor or other type of sensor.

Clean Water Tank Fluid Level

This field indicates a tank fluid level. The clean water tank level is monitored by a fluid sensor. The fluid sensor may include a capacitive sensor, a float based sensor, optical sensor or other type sensor.

Chemical Sanitation Fluid Level

This field indicates a tank fluid level. In one embodiment, a chemical sanitation fluid level is monitored by a fluid sensor. The fluid sensor may include a capacitive sensor, a float based sensor, optical sensor or other type of level sensor.

Soap Fluid Level

This field indicates a tank fluid level. The fluid level of soap or other hand washing chemical is monitored by a fluid sensor. The fluid sensor may include a capacitive sensor, a float based sensor, optical sensor or other type of sensor.

Toilet Tissue Stock Level

This field indicates the remaining quantity of toilet tissue. A sensor coupled to a toilet tissue dispenser provides a signal as to the level of remaining toilet tissue.

Hand Towel Stock Level

This field indicates the remaining quantity of hand towels. A sensor coupled to a hand towel dispenser provides a signal as to the level of remaining hand towels. In one embodiment, the towel level sensor includes a resistive element operated by an arm in contact with a supply of towels.

Tip-Over Switch Output

This field indicates if the PSU has been overturned. A tip-over switch provides a signal to indicate if PSU 115 has been upset. In one embodiment, a first GPS receiver and a second GPS receiver is mounted on PSU 115 and depending on the relative locations of each receiver, the orientation of the PSU can be determined. Other means of determining if the unit has tipped, or the orientation of PSU 115 are also contemplated.

Temperature Sensor

This field indicates a measured temperature. A sensor indicates if freezing conditions are present. In one embodiment, at a predetermined temperature, an antifreeze additive is introduced to a holding tank. In one embodiment, at a predetermined temperature, an electric heater is energized.

Courtesy Light Bulb Sensor Output

This field indicates if a courtesy bulb has extinguished. A courtesy light within PSU 115 may be monitored with a bulb monitor or optical sensor.

Battery Level Sensor

This field indicates the condition of a battery. A battery level sensor provides condition information for battery powering the PSU. In one embodiment, this field indicates if a solar power cell is charging the battery. In one embodiment, if the battery level drops below a predetermined threshold, an alarm signal is transmitted to a central monitoring station.

Line Voltage Available Signal

The PSU may be connected to metered electric service and this field indicates if that power is available. In one embodiment, if the metered line service is interrupted for a time in excess of a predetermined threshold, an alarm signal is transmitted to a central monitoring station.

Anti-Tamper Sensor Output

This field indicates if the unit has suffered tampering. An anti-tamper sensor may include one or more accelerometers placed on or about the PSU at strategically selected locations. For example, an accelerometer coupled to an entry door may indicate that the door was slammed with excessive force and that PSU 115 may have been vandalized.

Memory Status Signal

This field indicates the available storage capacity of a particular memory accessible to processor 140.

Archival Data

This field indicate that archival data is available at PSU 115 corresponding to historical service or other data.

User Convenience Equipment Status

This field indicates that condition or availability of user convenience equipment. A user accessible emergency assist request button may be available. Also, a microphone or video camera may be provided. Other user convenience equipment may include a microphone, camera, emergency assist request button.

Wireless Communication Facilities Available

This field identifies available wireless communication protocols. For example, a particular PSU may be equipped to communicate using BLUETOOTH®, cellular or pager technology.

System Test

This field indicates the results of a system test routine. In one embodiment, a system test is performed on power up or at predetermined intervals or upon a predetermined condition or event. For example, in one embodiment, a system test includes checking functionality of one or more sensors, processor memory, processor functionality and transmitter functionality. In one embodiment, upon completion of a system test, the results of the test are stored in memory, displayed on a panel and transmitted wirelessly to a remote service facility.

Remotely Controllable Actuators

This field indicates what actuators are available for remote control. Actuators allows operators to remotely release additional supplies of toilet tissue, paper products, chemicals or turn on a camera, microphone, or display a message on a display panel. In one embodiment, a remotely operable lock on the entry door can be operated when the PSU has reached maximum use capacity.

Alternative Embodiments

Variations of the above embodiments are also contemplated. For example, in one embodiment, bar coded data is provided on a surface of PSU 115 and an optical wand is used to retrieve stored data.

In one embodiment, data displayed on a website corresponds to one or more individual PSUs. From the website, an operator can check fluid levels, unit condition and perform selected control tasks.

In one embodiment, a display panel is concealed behind a locked or hidden access panel. In one embodiment, a keypad panel is concealed behind a locked or hidden access panel.

In one embodiment, processor 140 of PSU 115 executes programming adapted to diagnose a condition based on the output signals received from one or more sensors and transmits a predetermined signal corresponding to the sensed condition. In one embodiment, the output signals from the sensors is stored and communicated to a remote monitoring facility where the data is processed and a diagnosis is determined.

In one embodiment, sensor 130 includes an inclinometer coupled to processor 140 of PSU 115. In the event that processor 140 determines that PSU 115 has exceeded a predetermined inclination, then a predetermined event occurs. For example, at a 5° angle of inclination with respect to a reference, processor 140 causes a warning bit to be set in a memory register. At a 20° angle, processor 140 causes a signal to be transmitted to a central monitoring facility. Other threshold angles and responses are also contemplated. For example, if the inclination of PSU 115 exceeds a predetermined level, then the entry door is secured with a lock controlled by processor 140.

In addition to angle of incline, one embodiment provides that other parameters are monitored and suitable responses are programmed. For example, in one embodiment, if the detected geographical location of PSU 115 is at a location greater than a predetermined distance from a proscribed location, then an alarm is triggered. In one embodiment, a police authority is notified if PSU 115 is greater than 500′ from a predetermined location or if PSU 115 is moved more than 500′.

In one embodiment, PSU 115 establishes a communication link with a central monitoring station. The central monitoring station provides an interface to field service personnel, emergency services, a registered owner or lessee or to other authorized parties. In one embodiment, PSU 115 establishes a communication link with field service personnel via a wired or wireless communication channel.

In one embodiment, sensor 130 includes a burglar alarm. If PSU 115 is moved without authorization, an alarm is triggered. In one embodiment, a passive infra red (PIR) sensor is coupled to PSU 115 and positioned to detect an occupant. If an occupant is detected at a time when the entry door is otherwise locked, an alarm event is triggered. Other types of security alarm sensors are also contemplated for PSU 115. In one embodiment, central monitoring station treats PSU 115 in an “armed” condition and in a “disarmed” condition if an authorized user or service technician is using the facility.

In one embodiment, processor 140 polls each sensor output on a scheduled basis and if a sensor fails to respond within predetermined parameters, an alarm condition is triggered and the central monitoring station receives notification. In one embodiment, a PSU 115 is programmed to transmit a status signal on a predetermined schedule. Failure to receive the status signal at a central monitoring station, or other designated authority, causes an alarm event to be triggered. In one embodiment, a field service technician is notified of a detected anomaly at a particular PSU 115.

### Conclusion

The above description is intended to be illustrative, and not restrictive. Many other embodiments will be apparent to those of skill in the art upon reviewing the above description.

What is claimed is:

1. A system comprising:
a portable toilet unit;
a sensor coupled to the unit and adapted to provide a signal based on a sensed condition of the unit; and
a wireless transmitter coupled to the sensor and adapted to transmit a wireless signal.

2. The system of claim 1 wherein the sensor includes a fluid level detector.

3. The system of claim 1 wherein the sensor includes a paper quantity detector.

4. The system of claim 1 further including a location detection unit coupled to the transmitter.

5. The system of claim 4 wherein the location detection unit includes a global position system (GPS) receiver.

6. The system of claim 1 wherein the sensor includes a tip-over detector.

7. The system of claim 1 wherein the sensor includes a temperature detector.

8. The system of claim 1 wherein the sensor includes a light monitor.

9. The system of claim 1 wherein the sensor includes a battery level sensor.

10. A system comprising:
a portable toilet means;
a location sensing means coupled to the toilet means to determine a geographical location of the toilet means; and
a wireless communication means coupled to the location sensing means, the wireless communication means adapted to wirelessly transmit the geographical position to a remote facility.

11. The system of claim 10 further including a fluid level sensor means coupled to the wireless communication means and coupled to the toilet means, the fluid level sensor means adapted to provide a signal to the wireless communication means based on a fluid level.

12. The system of claim 10 further including an accelerometer means coupled to the wireless communication means and coupled to the toilet mean, the accelerometer means adapted to provide a signal to the wireless communication means based on a detected acceleration.

13. The system of claim 10 further including a user operable control means coupled to the wireless communication means and coupled to the toilet mean, the user operable control means adapted to provide a signal to the wireless communication means based on a detected acceleration.
